(19) United States
(12) Patent Application Publication
(10) Pub. No.: US 2008/0238112 A1
(43) Pub. Date: Oct. 2, 2008

(54) TRIM PANEL TETHER AND METHOD

(75) Inventors: Mike Eberlein, Farmington Hills, MI (US); Giri Giridhar, Farmington Hills, MI (US); Andrew Brant, Farmington Hills, MI (US); Jessica L. Wingett, Farmington Hills, MI (US)

Correspondence Address: YOUNG & BASILE, P.C., 3001 WEST BIG BEAVER ROAD, SUITE 624, TROY, MI, 48084, US

(73) Assignee: Nissan Technical Center North America, Inc., Farmington Hills, MI (US)

(21) Appl. No.: 11/692,975

(22) Filed: Mar. 29, 2007

(51) Int. Cl. E05C 17/04

(52) U.S. Cl. 292/262

(57) ABSTRACT

A trim panel cover tether and method for use with interior trim cover panels or audio speakers grilles. A deformable tether strap is engaged with the trim panel substrate and the cover panel to deter undesirable rattles of the speaker grille and to prevent complete detachment of the cover panel from the trim panel substrate in the event the cover panel is dislodged from the substrate.

### FIELD OF THE INVENTION

The present invention relates to tethers used to secure automotive trim panel covers, for example audio speaker grilles, to trim panels preventing undesired rattling of the grilles and complete detachment of the grilles from the trim panels on dislodgement of the cover.

### BACKGROUND

Automotive interior trim panels cover for concealing the sheet metal body structures, wires and other components from view are common in today vehicles. With the ever increasing demand of additional accessories, for example, increased numbers of audio speakers for premium sound systems, additional speaker grilles and other closure panels are required to cover such speakers and accessories.

Most luxury automobiles include six or more audio speakers which are typically recessed and concealed behind a trim panel through a speaker grille or other closure panel. The speakers are typically recessed in concave cavities molded into the trim panel or are placed in holes through the trim panel and attached to the body structure or other speaker mounting brackets. The speaker grilles typically include locking tabs that snap into the trim panel recesses or other fasteners to keep the speaker grilles in place.

Due to manufacturing and assembly variances, speaker grilles often, either initially or after vehicle use, have a tendency to rattle or make noise due to the lack of firm and engaging contact with the enjoining trim panel. It may also occur in the assembly or use that one or more of the speaker grille locking tabs may break off or fatigue under heat and stress further allowing the speaker grille to rattle or make other unwanted noises. To deter unwanted squeaks and rattles, pieces of foam tape are currently used between the grille and trim panel which adds cost, assembly time and are of limited effectiveness and duration.

It is also common that auto manufacturers will use the same basic trim panel for their luxury models as their economy models to reduce the number of different panels to be designed and manufactured. When using the same trim panel in an economy model, it is common for one or more of the speakers included in the luxury models to not be used in an economy model. As the same trim panel is used, the same speaker grille or other closure panel must be used to cover the cavity or hole although an actual speaker is not present. The lack of a physical speaker or other concealed accessory may further add to the tendency of the speaker grille or closure panel to rattle or squeak on initial installation or at some point during the long life of the vehicle.

In addition, with the ever growing need of safety features in vehicles, auto manufacturers strive to ensure that snap on accessories and covers, for example, speaker grilles and other closure panels remain in place during vehicle impacts or deployment of safety airbags to prevent them from entering the passenger compartment.

### SUMMARY

It would be desirable to provide a trim panel cover tether which reduces the likelihood of the trim closure panels or covers from rattling and squeaking during the life of a vehicle. It is further desirable to provide a trim panel cover tether that prevents complete detachment of the closure panel from the trim panel in the event of an impact or other event that may dislodge the closure panel from the trim panel. It is further desirable to provide a tether which accomplishes both the above objectives which is inexpensive, easy to install and is durable in use.

In one embodiment of the invention, a tether strap is used to secure a closure panel to a trim panel substrate. The tether includes a flexible, deformable strap having a first end attached to a trim panel substrate, a second end attached to a closure panel and a middle portion between the ends. On installation of the closure panel to the substrate, the strap is deformed in one or more bends in the middle portion. On complete installation of the closure panel to the substrate, the deformed and compressed strap exerts a compressive force against the closure panel thereby resisting movement of the closure panel with respect to the substrate. In the event that the closure panel is dislodged from the substrate, the tether on dissipation of the bends in the middle portion is stretched and exerts a tension force toward the substrate preventing the closure panel from completely detaching from the substrate and thereby entering the passenger compartment.

In an alternate embodiment, the strap is, semi-rigid and integrally molded into the closure panel and engages the substrate providing the compressive force against the closure panel resisting relative movement.

In an alternate embodiment, the flexible, deformable strap is compressed through several bends in the middle portion of the strap about rotational axes between the first and second ends to provide the compressive force desired and to accommodate the available space between the closure panel and the substrate.

Other applications of the present invention will become apparent to those skilled in the field when the following description of the best mode contemplated for practicing the invention is read in conjunction with the accompanying drawings.

### BRIEF DESCRIPTION OF THE DRAWINGS

The description herein makes reference to the accompanying drawing wherein like reference numerals refer to like parts throughout the several views and wherein:

FIG. 1 is an isometric view of the tether in an uninstalled and underformed state;

FIG. 2 is a schematic sectional view showing the tether installed with a closure panel in a trim panel cavity;

FIG. 3 is schematic sectional view of another embodiment of the installed tether deformed in two bends;

FIG. 4 is a schematic sectional view of another embodiment showing the tether installed in a closure panel having a through hole;

FIG. 5 is a schematic sectional view of another embodiment showing the tether installed with a closure panel with the strap engaged to a side wall of the substrate;

FIG. 6 is schematic sectional view of another embodiment of the tether installed with an alternate closure panel in a substrate cavity;

FIG. 7 is a schematic sectional view of an alternate embodiment of the tether as a semi-rigid part of the closure panel; and

FIG. 8 is a schematic sectional view of the installed tether in a non-deformed state when the closure panel is dislodged from the substrate.

### DETAILED DESCRIPTION

Referring to FIGS. 1-8, several embodiments of the trim panel tether and method are illustrated. The tether is useful in securing a trim closure panel, for example an automotive speaker grille, to an automotive trim panel or other vehicle structure. The tether is particularly useful in deterring the speaker grille or other closure panel from rattling or squeaking in use. The tether is further useful in preventing complete detachment of the speaker grille from the trim panel.

Referring to FIG. 1, tether 10 includes elongate strap 20 having a first end 22, a second end 24 and a middle portion 30 positioned between the first 22 and second 24 ends. In a preferred embodiment, strap 20, first end 22 and second end 24 are generally rounded as shown in FIG. 1 and include a first hole 32 and a second hole 34 positioned adjacent the respective ends. Strap 20 includes a first linear length 36 generally defined between the center lines of first hole 32 and second hole 34. In a preferred embodiment, the first linear length is approximately 2½ inches (63.5 mm) and approximately 1/16 inches (1.5875 mm) in thickness. Tether strap 12 may be manufactured from a flexible elastomer, a polymer such as polypropylene, other polymers, thin metal and other materials known by those skilled in the art. It is understood that other sizes, shapes thicknesses and configurations may be used without deviating from the present invention.

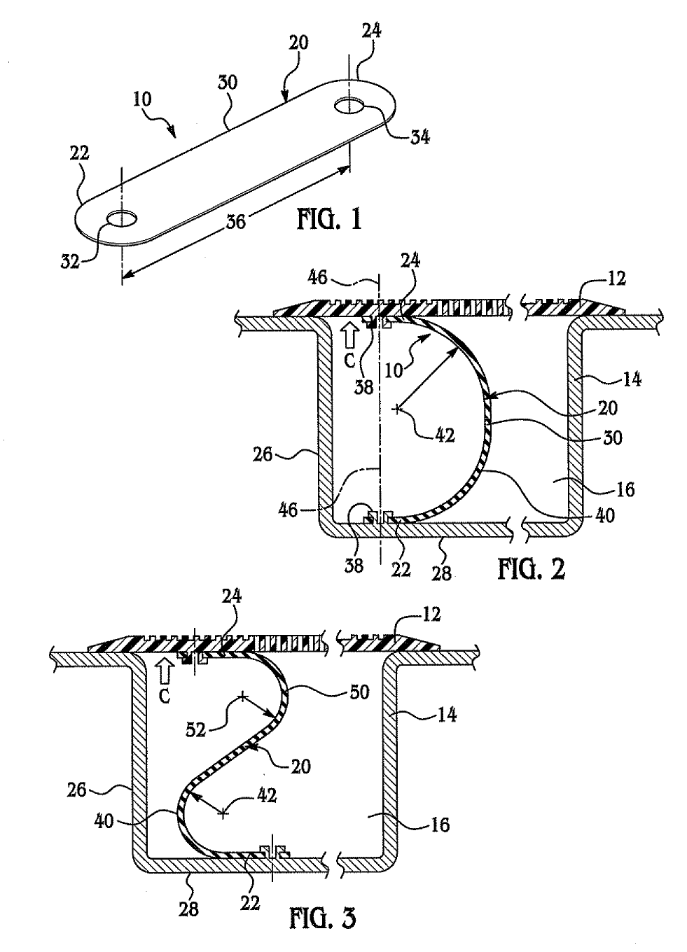

Strap 20 is engaged with trim panel substrate 14 generally shown in FIGS. 2-8. In a preferred embodiment, trim panel substrate 14 includes a cavity 16 defined by side walls 26 and a lower wall 28 whereby strap 20 first end 22 engages substrate 14 at lower wall 28. In a preferred embodiment, first end 22 is mechanically fastened to substrate 14 by a fastener 38. In a preferred embodiment, fastener 38 is integrally molded into substrate 14 and engages strap 20 through hole 32. In an alternate embodiment, for example as shown in FIG. 8, conventional fasteners such as screws, plastic push clips and other fasteners known by those skilled in the art may be used with deviating from the invention.

Strap 20 second end 24 is similarly engaged with a trim closure panel 12, for example, an automotive audio speaker grille, as generally shown FIG. 2-8. In a preferred embodiment, strap 20 is mechanically secured to closure panel 12 through a fastener 38 as described for the first end 22. It is understood that the methods of engaging the first end 22 and second end 24 may vary from each other depending on the application.

Referring to FIGS. 2-8, following attachment of strap 20 to substrate 14 and closure panel 12, during installation of trim closure panel 12 to substrate 14, tether strap 20 is compressed and deformed into a generally “U” or reverse “C” shape as generally shown in FIG. 2. Through such physical compression and deformation of strap 20 and the flexible and elastic properties of strap 20, a compressive force C in the general direction along a first linear axis 46, is exerted by strap 20 against closure panel 12. When closure panel 12 is in the installed position, for example as shown abutting substrate 14, closure panel 12 is removeably secured by screws, clips or other devices (not shown). In a typical installation, integral closure panel tabs 62 are used as generally shown in FIG. 6.

The compressive force C produced by strap 20 in an outward direction generally along the first linear axis 46 places a substantially constant outward force on closure panel 12 thereby resisting relative movement of closure panel 12 with respect to substrate 14 thereby reducing squeaks, rattles and other unwanted noise or vibration caused by a loose or loosened condition of the closure panel 12 from substrate 14.

In an alternate embodiment to the “U” or reverse “C” shape of strap 12 in FIG. 2, FIGS. 3-6 show different configurations for the installed strap 20. In these different configurations, strap 20 linear length 36 is of length such that strap 20 maybe deformed and compressed into a generally “Z” configuration. In these embodiments, a first bend 40 and an opposing second bend 50 are imparted to middle portion 30 generally about a first rotational axis 42 and second rotational axis 52 respectively. As also shown in FIG. 6, closure panel 12 may include locking tabs 62 extending from closure panel 12 including first locking members 66 at distal ends thereof On installation of closure panel 12 to substrate 14, locking tab 62 and first locking member 66 on installation, lockingly engage second locking members 70 and substrate 14 as generally shown. On installation of closure panel 12, strap 20 similarly exerts a compressive force C against a first surface 60 of closure panel 12 forcing first locking member 66 into contact with second locking member 70 or in the alternative, provides an increasing engagement force if already in contact, to resist relative movement between closure panel 12 and trim panel 14 reducing or eliminating squeaks, rattles and other unwanted noises and vibrations.

Referring to FIG. 4, in an alternate embodiment, panel substrate 14 does not include a closed cavity 16 having a bottom wall 28. In this embodiment, there is a through hole in trim panel 14 with sidewalls 26. In this embodiment, strap 20 first end 22 is engaged with vehicle body structure 18, for example, vehicle body sheet metal, other adjacent trim substrate or brackets. Similar to the other embodiments, first end 22 is preferably mechanically secured by a integral locking fastener 38 or traditional mechanical fasteners such as screws, clips and other fasteners known to those skilled in the art. It is understood that side walls 26 could also be removed leaving an unflanged opening in substrate 14.

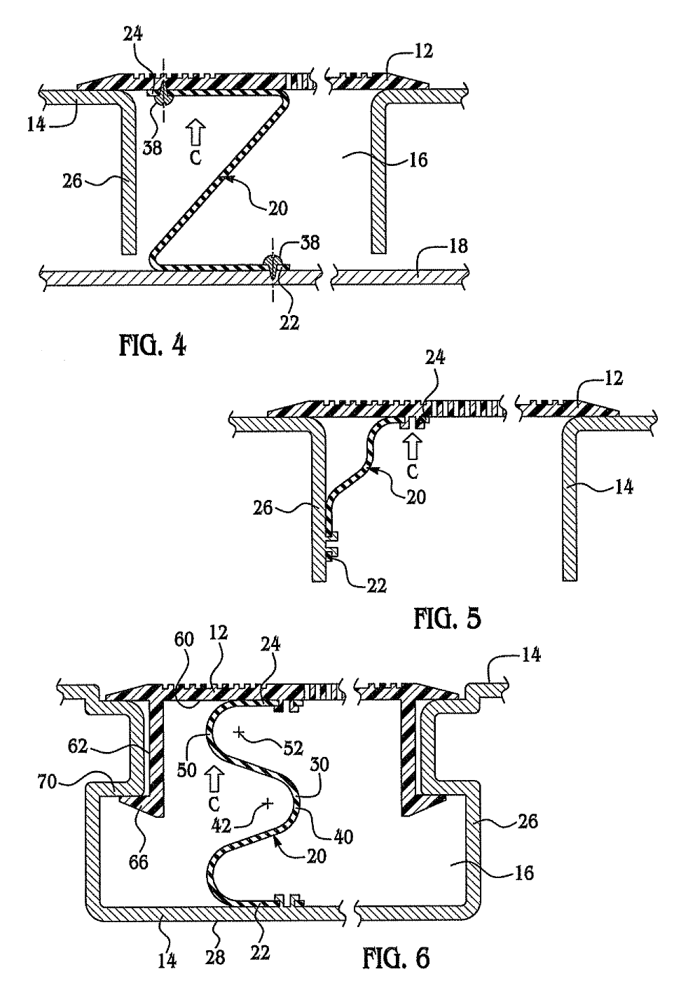

Referring to FIG. 5, in an alternate embodiment, substrate 14 does not include a closed cavity 16 as previously described, but includes a through hole having side walls 26 as generally shown. First end 22 is similarly engaged with a sidewall 26 as previously described and illustrated.

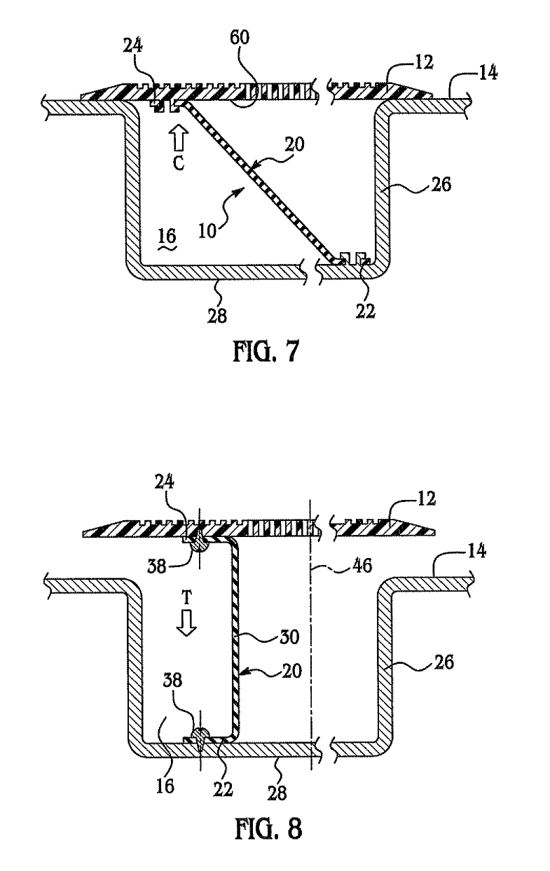

Referring to FIG. 7, an alternate embodiment of tether 10 is illustrated. In this embodiment, strap 20 is a semi-rigid strap extending from the first surface 60 of closure panel 12 down to first end 22. On engagement of strap 20 to substrate 14 and installation of closure panel 12 to substrate 14, compressive force C is generated in upward direction against closure panel 12 to resist relative movement between closure panel 12 and substrate 14 as previously described. In a preferred aspect of this embodiment, strap 20 is integrally molded into closure panel 12 as shown. It is understood that a separate strap 20 can be engaged or attached to closure panel 12 and substrate 14 as previously described. It is further understood that different shapes and configurations of strap 20 may be used other than a generally straight, diagonal shape as shown without departing from the invention. It is further understood that the various details and configurations shown in FIGS. 2-7 can be interchanged and used without deviating from the invention.

Referring to FIG. 8, on dislodgement or separation of closure panel 12 from substrate 14, closure panel 12 would typically fall away or project from its normally engaged position adjacent to substrate 14. This is particularly the case if a significant impact in the area adjacent the closure panel 12 forceably dislodges and projects closure panel 12 away from substrate 14. As shown, as closure panel 12 is displaced or projected in a direction generally along first linear axis 46 generally away from substrate 14, strap 20 begins to elongate across middle portion 30 dissipating or removing the bend or bends and potential energy as closure panel 12 moves away from substrate 14. When middle portion 30 reaches its first linear length 36 as a straight line as illustrated, and attempts to move beyond first linear length 36, tether strap 20 exerts a tension force T in the general direction shown toward first end 22 to prevent further linear displacement of closure panel 12 away from substrate 14. This tethered or restrained condition of closure panel 12 relative to substrate 1 4 prevents complete detachment and unwanted displacement or projection of closure panel 12 into the passenger compartment or another undesirable area. Continued attachment of closure panel 12 to substrate 14 further provides ease in re-engaging closure panel 12 to substrate 14 as closure panel 12 remains in close proximity to its original engagement position to cover cavity 16.

A method of securing the closure panel 12 to trim panel substrate 14 using the inventive tether 10 proceeds as follows. An elongate deformable tether strap 20 as previously described having a first end 22, a second end 24 and a middle portion 30 is provided. In a preferred method of use, tether strap 20 is positioned in cavity 16 formed in a trim panel substrate 14. First end 22 is engaged with substrate 14 and second end 24 is engaged with surface 60 on the underside of closure panel 12. On approaching the installed or removable locking position of closure panel 12 to substrate 14, strap 20 middle portion 30 is deformed and compressed producing one or more bends or curvatures in middle portion 30. The physical deformation and compression configuration of strap 20, and the resilent and elastic properties of the strap 20 produce a compressive force C in a direction generally away from first end 22 along first linear axis 46 against closure panel 12. In the installed position of closure panel 12 to substrate 14, compressive force C exerts a substantially constant compressive force thereby resisting relative movement of closure panel 12 with respect to substrate 14 to deter or eliminate squeaks, rattles or other undesirable vibrations between closure panel 12 and substrate 14.

On dislodgement of closure panel 12 from its installed position in substrate 14, as closure panel 12 moves away from substrate 14, strap 20 extends to its first linear length 36. Any further movement of closure panel 12 away from substrate 14 beyond first linear length 36 produces a tension force T in a general direction toward first end 22 thereby preventing complete detachment of closure panel 12 from substrate 14.

While the invention has been described in connection with what is presently considered to be the most practical and preferred embodiment, it is to be understood that the invention is not limited to the preferred embodiment but, on the contrary, it intended to cover various embodiments, modifications and equivalent arrangements included within the spirit and scope of the appended claims, which scope is to be accorded the broadest interpretation so as to encompass all such modifications and equivalent structures.

What is claimed is:

1. A tether for use in securing a closure panel to a substrate, the tether comprising:
an elongate deformable strap having a first end, a second end and a middle portion between the first and the second ends, the first end engaged with the substrate and the second end engaged with the closure panel, whereby the strap exerts a compressive force against the closure panel in a direction away from the first end when the strap is deformed and exerts a tension force at the second end in a direction toward the first end when there is no deformation thereby resisting movement of the closure panel when the closure panel is attached to the substrate and preventing complete separation of the closure panel from the substrate on dislodgement of the closure panel from the substrate.

2. The tether of claim 1 wherein the substrate is an automotive interior trim panel including a cavity at least partially covered by the closure panel.

3. The tether of claim 1 wherein the strap is integrally formed with the closure panel.

4. The tether of claim 1 wherein the closure panel is an audio speaker grille.

5. The tether of claim 1 wherein the deformation in the strap is a bend in the middle portion positioned about a first rotational axis positioned between the first and the second ends.

6. The tether of claim 1 wherein the strap deformation comprises a plurality of consecutive and opposing bends along the middle portion.

7. The tether of claim 1 wherein the closure panel further comprises a first surface and a locking tab extending from the surface substantially along a first linear axis, the tab having a first locking member at an end opposite the first surface for mating and opposing engagement with a second locking member on the substrate along the first linear axis to deter separation of the closure panel from the substrate along the first linear axis.

8. A tether for use between a removable closure panel and a substrate, the tether comprising:
an elongate deformable strap having a first end, a second end and a middle portion between the first and second ends, the first end positioned in opposing orientation from the second end in a direction along a first linear axis through a first bend in the middle portion about a first rotational axis positioned between the first and second ends causing a biasing force in the strap at the second end away from the first end along the first linear axis.

9. The tether of claim 8 further comprising a second bend in the middle portion about a second rotational axis positioned between the first and the second ends linearly distant from the from the first rotational axis.

10. The tether of claim 8 wherein the first end is compressingly engaged with a substrate having a cavity and the second end is compressingly engaged with a closure panel at least partially covering the substrate cavity.

11. The tether of claim 8 wherein the first end is attached to a substrate having a cavity and the second end is attached to a closure panel thereby preventing further linear separation of the enclosure panel from the substrate beyond a linear length between the first and the second ends due to a tension force in the strap exerted between the first and the second end when the second end is at the linear length from the first end along the first linear axis.

12. The tether of claim 8 wherein the strap is made from at least one of polypropylene, an elastomer, and a metal.

13. A tethered closure panel apparatus for use with an interior trim panel of automotive vehicles, the apparatus comprising:
a trim panel having a cavity defining a first linear axis through the cavity;
a closure panel in locking engagement with the trim panel at least partially covering the cavity;
an elongate deformable tether strap having a first end, a second end and a middle portion defining a first length between the first and the second ends, the first end is engaged with a substrate distant from the closure panel along the first linear axis, the second end is engaged with the closure panel, the strap is oriented to include first bend in the middle portion about a first rotational axis positioned between the first and the second ends creating a compression force in the strap at the second end against the closure panel in a direction away from the first end, at least a portion of the compressive force being along the first linear axis.

14. The apparatus of claim 13 wherein the substrate is located on a portion of the trim panel.

15. The apparatus of claim 13 wherein the substrate is independent of the trim panel.

16. The apparatus of claim 13 wherein the closure panel further comprises a first surface and a locking tab extending from the surface substantially along the first linear axis, the tab having a first locking member at an end opposite the first surface for mating and opposing engagement with a second locking member on the trim panel along the first linear axis to deter separation of the closure panel from the trim panel along the first linear axis.

17. The apparatus of claim 16 wherein the compressive force biases the first locking member against the second locking member to deter relative movement between the closure panel and the trim panel.

18. The apparatus of claim 13 wherein the strap further comprises a first length between the first and the second ends and wherein the strap prevents further separation of the closure panel from the trim panel beyond the first length of the strap through a tension force in the strap between the first and the second ends in a direction toward the first end on dislodgement of the closure panel from the trim panel.

19. A method of securing a closure panel to a substrate comprising the steps of:
providing an elongate deformable tether strap having a first end, a second end and a middle portion between the first and the second ends;
engaging the first end to a substrate;
engaging the second end with a closure panel;
deforming the tether strap to create a biasing force in the strap at the second end in a direction away from the first end; and
attaching the closure panel to the substrate against the biasing force producing a compressive force on the closure panel in the direction away from the first end.

20. The method of claim 19 further comprising creating a tensioning force in the tether strap at the second end in a direction toward the first end on dissipation of the deformation preventing complete separation of the closure panel from the substrate.

21. The method of claim 19 wherein the deformation is a bend in the middle portion of the strap.
